(19) United States
(12) Patent Application Publication
(10) Pub. No.: US 2024/0418618 A1
(43) Pub. Date: Dec. 19, 2024

(54) METHOD FOR EVALUATING CHARACTERISTICS OF MAGNETORHEOLOGICAL FLUID

(71) Applicant: CK MATERIALS LAB CO., LTD., Ansan-si Gyeonggi-do (KR)

(72) Inventors: Hyeong Jun KIM, Ansan-si Gyeonggi-do (KR); Seong Jun SHIN, Ansan-si Gyeonggi-do (KR); Jeong Hoon KIM, Ansan-si Gyeonggi-do (KR); Seung Hyun SON, Ansan-si Gyeonggi-do (KR)

(73) Assignee: CK MATERIALS LAB CO., LTD., Ansan-si Gyeonggi-do (KR)

(21) Appl. No.: 18/814,886

(22) Filed: Aug. 26, 2024

Related U.S. Application Data
(63) Continuation of application No. PCT/KR2022/010880, filed on Jul. 25, 2022.

(30) Foreign Application Priority Data
Feb. 28, 2022 (KR) 10-2022-0025965

(51) Int. Cl. G01N 11/06; G01N 11/00; G01N 15/04

(52) U.S. Cl. CPC G01N 11/06; G01N 15/04; G01N 2011/0066

(57) ABSTRACT

The present invention relates to a method for evaluating the characteristics of a magnetorheological fluid. The method for evaluating the characteristics of magnetorheological fluid, according to the present invention, is for evaluating the characteristics of magnetorheological fluid comprising a dispersion medium and magnetic particles and is characterized by comprising the following steps: (a) preparing a container in which a magnetorheological fluid is filled or a flow channel in which a magnetorheological fluid flows; (b) placing a coil part such that the container or flow channel is positioned in the hollow portion of the coil part; and (c) using the coil to measure an impedance signal or inductance signal with respect to the magnetorheological fluid.

### CROSS-REFERENCE TO RELATED APPLICATIONS

This application is a continuation of International Application No. PCT/KR2022/010880 filed on Jul. 25, 2022, which claims priority to Korean Patent Application No. 10-2022-0025965 filed on Feb. 28, 2022, the entire contents of which are herein incorporated by reference.

### TECHNICAL FIELD

The present invention relates to a method for evaluating the characteristics of a magnetorheological fluid. More specifically, it relates to a method for evaluating characteristics of a magnetorheological fluid, such as content, concentration, sedimentation rate, uniformity of dispersion, etc. of magnetic particles by measuring an impedance signal or inductance signal.

### BACKGROUND ART

A magnetorheological fluid (MRF), as a suspension in which micro-sized magnetic particles sensitive to magnetic fields are mixed in a dispersion medium such as oil or water, is one of smart materials whose flow characteristics can be controlled in real-time by applying an external magnetic field.

The magnetorheological fluid exhibits a magnetorheological phenomenon in which a rheological behavior, as well as electrical, thermal, and mechanical properties, change according to the external magnetic field. In general, when no external magnetic field is applied, a magnetorheological fluid exhibits Newtonian fluid properties. However, when an external magnetic field is applied, magnetic particles inside the magnetorheological fluid form a chain structure in a direction of the applied magnetic field, resulting in a shear force that inhibits the flow of the fluid or resistance to flow and exhibiting the properties of Bingham fluids that generate a constant yield stress even without a shear strain.

Since the magnetorheological fluid has the resistance to the flow, a rapid response speed, and a reversible characteristic, there is a high applicability to various industrial fields such as a vibration control device such as a damper, a clutch of a vehicle, a brake, etc.

In order for the magnetorheological fluid to be effectively utilized, the magnetorheological fluid should have a high yield stress, and the viscosity of the fluid must be sufficiently low so that the magnetorheological fluid can be quickly restored to an original state thereof when the magnetic field is removed again after the magnetic field is applied, and the magnetic particles inside the magnetorheological fluid should be evenly distributed in the dispersion medium.

However, since the density of the magnetic particles constituting the magnetorheological fluid (for example, tap density of iron particles of 3.9 to 4.1 g/cm³) is still larger than the density (for example, in the case of silicone oil, approximately 0.8 to 1.0 g/cm³ at room temperature) of the dispersion medium, the magnetic particles are sedimented by gravity in the dispersion medium, thereby reducing the dispersion stability of the magnetorheological fluid. Therefore, when the user uses the magnetorheological fluid, the user suffers from inconvenience that the magnetic particles and the dispersion medium sedimented and separated in a container should be remixed or re-dispersed, and the physical properties of the magnetorheological fluid may be changed during the re-mixing/re-dispersing process.

Additionally, the user needs to understand the characteristics of the magnetorheological fluid, such as the concentration and sedimentation rate of magnetic particles, within a container before using it. Conventionally, signals were measured externally from the magnetorheological fluid using an LCR meter; however, the intensity of the signals measured by this method was low, making it difficult to accurately evaluate the characteristics. If the characteristics are not accurately evaluated, re-mixing or re-dispersing the magnetic particles and the dispersion medium involves unnecessary additional processes, which is not economical and may lead to changes in the physical properties of the magnetorheological fluid due to the additional processes. Therefore, there is a need for research that can accurately evaluate the characteristics of a magnetorheological fluid.

### SUMMARY

### Technical Problem

Accordingly, the present invention is contrived to solve the problems in the related art and an object thereof is to provide a method for evaluating characteristics of a magnetorheological fluid, allowing for accurate measurement of characteristics of a magnetorheological fluid.

In addition, an object of the present invention is to provide a method for evaluating characteristics of a magnetorheological fluid, allowing for measuring the content, concentration, sedimentation rate, uniformity of dispersion, etc. of the magnetic particles of a magnetorheological fluid in a simple manner.

Further, an object of the present invention is to provide a method for evaluating characteristics of a magnetorheological fluid which allows the use of a magnetorheological fluid by performing minimal re-mixing/re-dispersing on a magnetorheological fluid in which magnetic particles are sedimented.

However, these objects are exemplary and the scope of the present invention is not limited thereto.

### Technical Solution

The above object of the present invention is achieved by a method for evaluating the characteristics of a magnetorheological fluid comprising a dispersion medium and magnetic particles, the method comprising the following steps of: (a) preparing a container in which a magnetorheological fluid is filled or a flow channel in which a magnetorheological fluid flows; (b) placing a coil part such that the container or flow channel is positioned in the hollow portion of the coil part; and (c) measuring an impedance signal or inductance signal with respect to the magnetorheological fluid through the coil part.

In addition, the above object of the present invention is achieved by a method for evaluating the characteristics of a magnetorheological fluid comprising a dispersion medium and magnetic particles, the method including the following steps of: (a) preparing a container in which a magnetorheological fluid is filled or a flow channel in which a magnetorheological fluid flows; (b) preparing a measuring part with a coil part placed inside or connected externally, (c) immersing the measuring part in the magnetorheological fluid; and (d) measuring an impedance signal or inductance signal with respect to the magnetorheological fluid through the coil part.

Additionally, according to an embodiment of the present invention, the container or a tube in which the flow channel is formed may be made of a non-magnetic or non-conductive material.

Additionally, according to an embodiment of the present invention, a case of the measuring part may be made of a non-magnetic or non-conductive material.

Additionally, according to an embodiment of the present invention, when the container or the flow channel is positioned in the hollow portion of the coil part, the magnitude of the impedance signal or inductance signal may be measured to be more than ten times greater than when the container or the flow channel is positioned in an outer peripheral region of the coil part.

Additionally, according to an embodiment of the present invention, as the content of magnetic particles in the magnetorheological fluid increases, a difference in the impedance signals or inductance signals may become greater when the container or the flow channel is positioned in the hollow portion of the coil part compared to when the container or the flow channel is positioned in the outer peripheral region of the coil part.

In addition, according to an embodiment of the present invention, when the coil part is immersed in the magnetorheological fluid, the magnitude of the impedance signal or inductance signal may be measured to be more than ten times greater than when the container or the flow channel is positioned in the outer peripheral region of the coil part.

In addition, according to an embodiment of the present invention, as the content of magnetic particles in the magnetorheological fluid increases, a difference in the impedance signals or inductance signals may become greater when the coil part is immersed in the magnetorheological fluid compared to when the container or the flow channel is positioned in the outer peripheral region of the coil part.

Additionally, according to an embodiment of the present invention, the impedance signal or inductance signal with respect to the magnetorheological fluid may be measured through the coil part for each height of the container filled with the magnetorheological fluid.

In addition, according to an embodiment of the present invention, a sedimentation rate of the magnetorheological fluid may be calculated based on (1) a difference between a first impedance signal measured at a first position in the container and a second impedance signal measured at a second position higher than the first position, or (2) a difference between a first inductance signal measured at a first position in the container and a second inductance signal measured at a second position higher than the first position.

In addition, according to an embodiment of the present invention, as time passes from a reference point in time, the difference between the first impedance signal and the second impedance signal, or the difference between the first inductance signal and the second inductance signal, may increase.

Additionally, according to an embodiment of the present invention, wherein as time passes from a reference point in time, (1) the first impedance signal may increase while the second impedance signal may decrease, or (2) the first inductance signal may increase while the second inductance signal may decrease.

Additionally, according to an embodiment of the present invention, a concentration of the magnetic particles of the magnetorheological fluid may be calculated by measuring the impedance signal or inductance signal with respect to the magnetorheological fluid through the coil part.

Additionally, according to an embodiment of the present invention, a plurality of coil parts spaced apart from one another along a vertical direction of the container may be prepared and the container is disposed in the hollow portions of at least two of the coil parts.

In addition, according to an embodiment of the present invention, the measuring part may include a plurality of coil parts arranged to be spaced apart from one another along a vertical direction of the container, and the measuring part may be immersed in the magnetorheological fluid such that heights of at least two of the coil parts of the measuring part are positioned lower than a topmost level of the magnetorheological fluid.

In addition, according to an embodiment of the present invention, the impedance signal or inductance signal with respect to the magnetorheological fluid may be measured through the coil part at least at two different points in time at a specific point in the container filled with the magnetorheological fluid. Additionally, according to an embodiment of the present invention, the measuring of the impedance signal or inductance signal with respect to the magnetorheological fluid through the coil part may include the steps of: (1) measuring the impedance signal or inductance signal at least at two points in time or at least at two points in the container or flow channel; and (2) determining whether a difference between the impedance signals or inductance signals measured at the at least two points in time or at the at least two points is greater than a set reference value.

In addition, according to an embodiment of the present invention, the measuring of the impedance signal or inductance signal with respect to the magnetorheological fluid through the coil part may include the steps of: (1) measuring the impedance signal or inductance signal at least at two points in time or at least at two points in the container or flow channel; and (2) determining whether each of the impedance signals or the inductance signals measured at the at least two points in time or at the at least two points falls within a preset reference value range.

In addition, according to an embodiment of the present invention, when the difference between the impedance signals or inductance signals measured at the at least two points in time or at the at least two points is greater than the set reference value, dispersion of the magnetorheological fluid may be further performed.

In addition, according to an embodiment of the present invention, the magnetorheological fluid may be used under the condition that the difference between the impedance signals or inductance signals measured at the at least two points in time or at the at least two points is equal to or less than the set reference value.

Additionally, according to an embodiment of the present invention, when the difference between the impedance signals or inductance signals measured at the at least two points in time or at the at least two points is out of the preset reference value range, dispersion of the magnetorheological fluid may be further performed.

In addition, according to an embodiment of the present invention, the magnetorheological fluid may be used when the difference between the impedance signals or inductance signals measured at the at least two points in time or at the at least two points is within the preset reference value range.

### Advantageous Effects

According to the present invention configured as described above, the effect of accurately evaluating the characteristics of a magnetorheological fluid is achieved.

Additionally, according to the present invention, the effect of allowing for the simple measurement of the content, concentration, sedimentation rate, uniformity of dispersion, etc. of the magnetic particles in the magnetorheological fluid is achieved.

Furthermore, according to the present invention, the effect of allowing the use of a magnetorheological fluid by performing minimal re-mixing/re-dispersing for the magnetorheological fluid in which magnetic particles are sedimented is achieved.

However, the scope of the present invention is not limited by such effects.

### BRIEF DESCRIPTION OF DRAWINGS

FIG. 1 illustrates schematic diagrams showing a method for evaluating the characteristics of a magnetorheological fluid according to an embodiment of the present invention.

FIG. 2 is a graph showing impedance values of samples according to methods (1) and (2) of FIG. 1.

FIG. 3 is a schematic diagram showing a method for evaluating the characteristics of a magnetorheological fluid according to another embodiment of the present invention.

FIG. 4 is a graph showing impedance values of samples according to methods (3) and (4) of FIG. 3.

FIG. 5 is a graph showing impedance values of samples with respect to frequency changes according to methods (1) and (2) of FIG. 1.

FIG. 6 is a graph comparing impedance values and inductance values of samples with respect to frequency changes according to an embodiment of the present invention.

FIG. 7 is a schematic diagram showing a measuring part according to an embodiment of the present invention.

FIG. 8 is a graph showing impedance variation values with respect to the measurement height of a sedimentation sample according to an embodiment of the present invention.

FIG. 9 illustrates graphs showing variation values of impedance with respect to the measurement height of a sedimentation sample after 1 month, 2 months, and 24 months according to an embodiment of the present invention.

FIG. 10 illustrates graphs showing impedance values with respect to the content of magnetic particles according to an embodiment of the present invention.

FIG. 11 is a graph showing saturation magnetization values with respect to the content of magnetic particles according to an embodiment of the present invention.

FIG. 12 illustrates graphs showing impedance values with respect to the type of magnetic particles in the magnetorheological fluid according to an embodiment of the present invention.

FIG. 13 is a flowchart showing the process of determining the concentration of magnetic particles in a magnetorheological fluid according to an embodiment of the present invention.

FIG. 14 is a graph showing the process of determining the concentration of magnetic particles in a magnetorheological fluid according to an embodiment of the present invention.

FIG. 15 is a flowchart showing the processes for use of a magnetorheological fluid, such as determining the time of completion of the manufacturing process, quality control of sedimentation or re-dispersibility, injection, etc. by determining the uniformity of dispersion of the magnetorheological fluid according to an embodiment of the present invention.

FIG. 16 is a schematic diagram showing a method for evaluating the characteristics of a magnetorheological fluid in a flow channel where the magnetorheological fluid flows according to an embodiment of the present invention.

FIG. 17 is a flowchart showing the process of evaluating the re-dispersibility of a magnetorheological fluid according to an embodiment of the present invention.

FIG. 18 is a schematic diagram showing a magnetorheological fluid damper according to an embodiment of the present invention.

FIG. 19 is a flowchart showing the operation process of a magnetorheological fluid system according to an embodiment of the present invention.

### DESCRIPTION OF REFERENCE NUMERALS

10: CONTAINER
10′: FLOW CHANNEL
20: MAGNETORHEOLOGICAL FLUID
30: COIL PART
35: HOLLOW PORTION
40: COIL CASE
50: MEASURING PART
60: MAGNETORHEOLOGICAL FLUID DAMPER

### DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the present disclosure, although different, are not necessarily mutually exclusive. For example, a particular feature, structure, or characteristic described herein in connection with one embodiment may be implemented within other embodiments without departing from the spirit and scope of the present disclosure. In addition, it is to be understood that the position or arrangement of individual elements within each disclosed embodiment may be modified without departing from the spirit and scope of the present disclosure. The following detailed description is, therefore, not to be taken in a limiting sense, and the scope of the present disclosure is defined only by the appended claims, appropriately interpreted, along with the full range of equivalents to which the claims are entitled. In the drawings, similar reference numerals refer to the same or similar functions over various aspects, and the length, area, thickness, and the like and the form may be exaggerated for convenience.

In the present specification, it should be understood that the term “include” or “have” indicates that a feature, a number, a step, an operation, a component, a part or the combination thereof described in the specification is present, but does not exclude a possibility of presence or addition of one or more other features, numbers, steps, operations, components, parts or combinations thereof, in advance.

Hereinafter, preferred embodiments of the present invention will be described in detail with reference to the accompanying drawings so that those skilled in the art may easily implement the present invention.

According to an embodiment of the present invention, a magnetorheological fluid may have a phase in which a liquid phase and a solid phase are converted or the liquid phase and the solid phase are mixed according to an external magnetic field. Magnetic particles included in the magnetorheological fluid may form a chain according to the external magnetic field, and thus exhibit properties similar to solids.

According to an embodiment of the present invention, the magnetorheological fluid may include a dispersion medium and magnetic particles dispersed in the dispersion medium, and may further include a thixotropic agent, an additive, etc.

The dispersion medium is a material that allows magnetic particles to be dispersed to form a suspension, and has a polar or non-polar property, and a low viscosity is preferable for a maximum magnetorheological effect.

For example, the dispersion medium may be at least one selected from the group consisting of silicone oil, mineral oil, paraffin oil, corn oil, hydrocarbon oil, castor oil, and vacuum oil. In addition, the dispersion medium may have a kinematic viscosity of 40° C. in the range of approximately 5 to 300 mm²/s. If the kinematic viscosity is less than this range, there may be a problem of lowering a sedimentation property, and if the kinematic viscosity is greater than this range, there may be a problem of lowering the fluidity, so it is preferable that the kinematic viscosity is included in the range.

The magnetic particles may be at least one selected from iron, carbonyl iron, iron alloy, iron oxide, iron nitride, iron carbide, low carbon steel, nickel, cobalt, and mixtures thereof, or alloys thereof. The average diameter of the magnetic particles may be approximately 1 to 100 μm. Additionally, the magnetic particles may be uncoated magnetic particles or magnetic particles coated with an organic resin or inorganic material.

For example, the magnetic particles may be included in the magnetorheological fluid in an amount of approximately 65 to 85 wt %. If the magnetic particles are included in an amount less than this range, it may lead to a decrease in shear stress, while inclusion in an amount greater than this range may cause issues with fluidity. Thus, it is preferable to include the magnetic particles within this range.

As the thixotropic agent is mixed and dispersed in the magnetorheological fluid, a known thixotropic agent may be used that causes the magnetorheological fluid to exhibit thixotropy.

Besides, the magnetorheological fluid may further include a dispersing agent, an antifriction agent, an antioxidant, and a corrosion inhibitor as conventional additives.

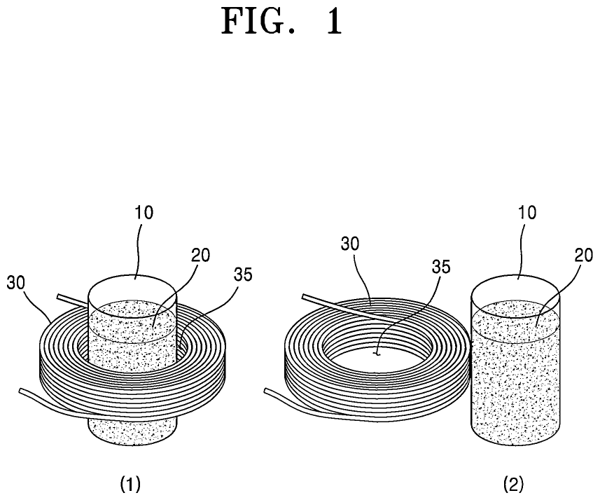

FIG. 1 illustrates schematic diagrams showing a method for evaluating the characteristics of a magnetorheological fluid according to an embodiment of the present invention. (1) of FIG. 1 illustrates an embodiment of the present invention, and (2) illustrates a method for evaluating the characteristics of a magnetorheological fluid according to a comparative example.

A method for evaluating the characteristics of a magnetorheological fluid according to an embodiment of the present invention may include the steps of (a) preparing a container 10 filled with a magnetorheological fluid 20, (b) placing a coil part 30 such that a hollow portion 35 of the coil part 30 is positioned in the container 10, and (c) measuring an impedance signal or inductance signal with respect to the magnetorheological fluid through the coil part 30.

Referring to (1) of FIG. 1, first, the container 10 filled with the magnetorheological fluid 20 may be prepared. The container 10 may be made of a material and shape that can accommodate the dispersion medium, magnetic particles, and the like constituting the magnetorheological fluid 20. For example, since the density of the magnetorheological fluid 20 is high, a material with high rigidity may be used to accommodate a large amount of the magnetorheological fluid 20, and preferably, a non-magnetic, non-conductive material may be used. To accommodate a relatively small amount of the magnetorheological fluid 20, materials such as glass or plastic may also be used. The container 10 may have a cylinder form so that it can be positioned in the hollow portion 35 of the coil part 30, and it is preferably of a cylindrical shape. When the container 10 has a cylindrical shape and arranged to be coaxial with the hollow portion 35 of the coil part 30, an electrical signal, such as the current applied by the coil part 30, may act more uniformly on the container 10 filled with the magnetorheological fluid 20.

Next, the coil part 30 may be arranged such that the container 10 is positioned in the hollow portion 35 of the coil part 30. This includes moving the coil part 30 to the container 10 at a fixed position or, conversely, moving the container 10 to the coil part 30 at a fixed position. The shape of the hollow portion 35 of the coil part 30 is preferably larger than or equal to the outer peripheral shape of the container 10 so that the container 10 can be positioned in the hollow portion 35.

The position of the hollow portion 35 may correspond to the magnetorheological fluid 20 filled in the container 10. In other words, it is preferable that the hollow portion 35 of the coil part 30 is positioned within the height range of the container 10 filled with the magnetorheological fluid 20 so that the coil part 30 can measure a larger impedance signal of the magnetorheological fluid 20.

Next, the impedance signal or inductance signal with respect to the magnetorheological fluid may be measured through the coil part 30. The coil conductive wire of the coil part 30 may substantially correspond to an RLC circuit. When an electrical signal, such as a current, is applied to the coil part 30, changes in the electrical signal may occur due to the interaction with the magnetic particles in the magnetorheological fluid 20 surrounding the coil part 30. These changes in the electrical signal may correspond to changes in impedance or inductance due to the interaction between the coil part 30 and the magnetorheological fluid 20. An impedance signal or inductance signal may be measured by connecting a signal measuring device (not shown) to both ends of the coil conductive wire of the coil part 30.

The impedance signal or inductance signal may correspond to the amount of magnetic particles dispersed at a specific position within the magnetorheological fluid 20. The impedance signal or inductance signal may vary depending on where the coil part 30 is placed within the magnetorheological fluid 20. The present invention is characterized by predicting the amount of magnetic particles in the magnetorheological fluid 20 at a location adjacent to the coil part 30 based on the impedance or inductance signal measured in the coil part 30. In particular, the impedance signal or inductance signal depending on the height within the container 10 filled with the magnetorheological fluid 20 may be used to calculate the amount of magnetic particles at the corresponding height. By calculating the amount of magnetic particles at least at two points within the overall height of the magnetorheological fluid 20, the sedimentation rate within the container 10 may be determined. The sedimentation rate S may be expressed as S(vol %)=100−[(ΔS)/(h)]×100, where ΔS is the height of a supernatant liquid (the top layer when the magnetic particles in the magnetorheological fluid are separated into layers due to sedimentation) after filling the container with magnetorheological fluid for a certain period of time, and h is the initial height of the magnetorheological fluid in the container.

Meanwhile, when placing the container 10 in the hollow portion 35 of the coil part 30, it is preferably considered that the container 10 is made of a non-magnetic, non-conductive material. If the container 10 is made of a magnetic or conductive material, when the coil part 30 interacts with the magnetorheological fluid 20 to measure an impedance signal or inductance signal, the measured value may include noise due to the interaction with the container 10. To exclude this noise, a non-magnetic, non-conductive material may be used for the container 10.

Referring to (2) of FIG. 1, in the method for evaluating the characteristics of a magnetorheological fluid according to the comparative example, the coil part 30 is placed outside the container 10. In other words, the container 10 is not positioned in the hollow portion 35 of the coil part 30.

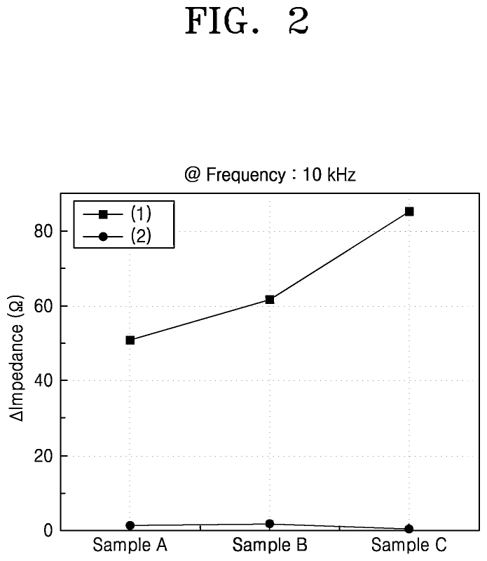

FIG. 2 is a graph showing impedance values of samples according to methods (1) and (2) of FIG. 1.

According to an embodiment, the variation value of impedance was measured by applying a 10-kHz electrical signal to the coil part 30 for samples A, B, and C. The impedance variation value represents the difference between the initial impedance value measured without any object to be measured around the coil part 30 (or in an atmospheric state) and the impedance value measured after placing the object to be measured around the coil part 30. Samples A, B, and C are magnetorheological fluids with magnetic particle contents of 72 wt %, 80 wt %, and 85 wt %, respectively. Keeping the coil part 30 at the same height of the container 10, the variation value of impedance was measured when the container 10 was placed inside the coil part 30 (or in the hollow portion 35) as shown in (1) of FIG. 1, and when the container 10 was placed outside the coil part 30 (or in the outer peripheral region) as shown in (2) of FIG. 1.

Referring to FIG. 2, it can be seen that the variation value of impedance is significantly larger in the case of (1) of FIG. 1, where the container 10 is placed inside the coil part 30 (or in the hollow portion 35). Regardless of the magnetic particle content, all samples showed that the variation value of impedance in (1) of FIG. 1 was significantly larger than in (2) of FIG. 1. It can be seen that the magnitude of the impedance signal in (1) of FIG. 1 was measured to be more than 10 times greater, approximately 25 to 80 times greater, than in (2) of FIG. 1. The method in (2) of FIG. 1 not only results in a smaller impedance variation value but also shows a lower value for sample C, which has the highest particle content, compared to samples A and B, indicating a high likelihood of errors.

As described above, the method for evaluating the characteristics of a magnetorheological fluid according to an embodiment of the present invention, by measuring the impedance signal with the magnetorheological fluid 20 placed in the hollow portion 35 of the coil part 30, results in a significantly larger signal, thereby enabling much more accurate and easier evaluation of characteristics compared to conventional technology.

In addition, from sample A to sample C, that is, as the content of magnetic particle in the magnetorheological fluid 20 increases, the impedance variation value is measured to be larger. Moreover, it can be seen that as the content of magnetic particles in the magnetorheological fluid 20 increases, the difference in impedance signals in case (1) of FIG. 1 becomes larger than in case (2) of FIG. 1. In other words, as the content of magnetic particles in the magnetorheological fluid 20 increases, the impedance variation value becomes larger.

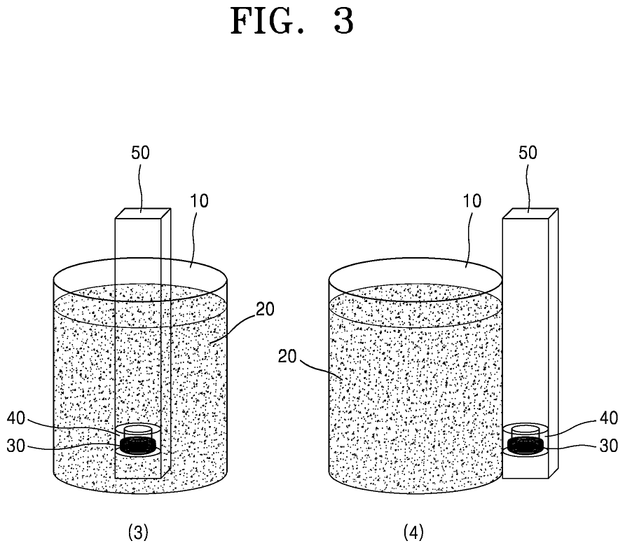

FIG. 3 is a schematic diagram showing a method for evaluating the characteristics of a magnetorheological fluid according to another embodiment of the present invention. (3) of FIG. 3 illustrates an embodiment of the present invention, and (4) illustrates a method for evaluating the characteristics of a magnetorheological fluid according to a comparative example.

A method for evaluating the characteristics of a magnetorheological fluid according to another embodiment of the present invention may include the steps of (a) preparing a container 10 filled with a magnetorheological fluid 20, (b) preparing a measuring part 50 with a coil part 30 placed inside, (c) immersing the measuring part 50 in the magnetorheological fluid 20, and (d) measuring an impedance signal or inductance signal with respect to the magnetorheological fluid through the coil part 30.

Referring to (3) of FIG. 3, first, a container 10 filled with a magnetorheological fluid 20 may be prepared. This is the same as described with reference to (1) of FIG. 1.

Next, a measuring part 50 with a coil part 30 placed inside may be prepared. The measuring part 50 is configured to enter from an open top of the container 10 and be at least partially immersed in the magnetorheological fluid 20. The measuring part 50 has preferably a length longer than or at least equal to the height of the container 10. The measuring part 50 may have a tubular shape with an empty space inside such that the coil part 30 can be placed. The measuring part 50 may have a shape that seals the coil part 30 to prevent magnetic particles from sticking to or aggregating around the coil part 30 when the measuring part 50 is immersed in the magnetorheological fluid 20. Alternatively, a coil case 40 may enclose and seal the coil part 30, and the coil case 40 may be connected to the measuring part 50.

Next, the measuring part 50 may be immersed in the magnetorheological fluid 20. This includes immersing the coil part 30 included in the measuring part 50 to a depth such that it is within the height range of the magnetorheological fluid 20 contained in the container 10. In other words, the coil part 30 should be positioned within the height range of the container 10 filled with the magnetorheological fluid 20 so that the coil part 30 can measure the impedance signal or inductance signal of the magnetorheological fluid 20.

Next, the impedance signal or inductance signal with respect to the magnetorheological fluid may be measured through the coil part 30. Both ends of the coil conductive wire of the coil part 30 extend to the outside through the space of the measuring part 50 and are connected to a signal measuring device (not shown), allowing the measurement of the impedance signal or inductance signal.

The impedance signal or inductance signal may correspond to the amount of magnetic particles dispersed at a specific position within the magnetorheological fluid 20. This invention is characterized by predicting the amount of magnetic particles in the magnetorheological fluid 20 at a location adjacent to the coil part 30 based on the impedance signal or inductance signal measured in the coil part 30. This is the same as described with reference to (1) of FIG. 1.

Meanwhile, when immersing the measuring part 50 in the magnetorheological fluid, it is preferably considered that the measuring part 50 (or the coil case 40) is made of a non-magnetic, non-conductive material. If the measuring part 50 is made of a magnetic or conductive material, when the coil part 30 interacts with the magnetorheological fluid 20 to measure an impedance signal or inductance signal, the measured value may include noise due to the interaction with the measuring part 50. To exclude this noise, a non-magnetic, non-conductive material may be used for the measuring part 50.

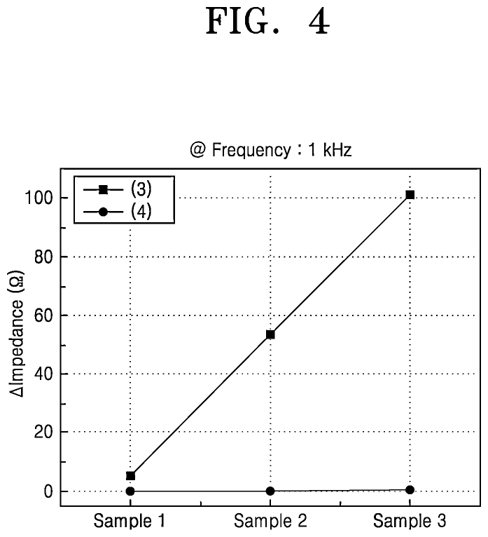

FIG. 4 is a graph showing impedance values of samples according to methods (3) and (4) of FIG. 3.

According to an embodiment, the variation value of impedance was measured by applying a 1-kHz electrical signal to the coil part 30 for samples 1, 2, and 3. Samples 1, 2, and 3 are magnetorheological fluids with magnetic particle contents of 30 wt %, 70 wt %, and 90 wt %, respectively. Keeping the coil part 30 at the same height of the container 10, the variation value of impedance was measured when the coil part 30 was placed inside the container 10 (or in the magnetorheological fluid 20) as shown in (3) of FIG. 3, and when the coil part 30 was placed outside the container 10 (or outside the magnetorheological fluid 20) as shown in (4) of FIG. 3.

Referring to FIG. 4, it can be seen that the variation value of impedance is significantly larger in the case of (3) of FIG. 3, where the coil part 30 is placed inside the container 10 (or inside the magnetorheological fluid 20). Regardless of the magnetic particle content, all samples showed that the variation value of impedance in (3) of FIG. 3 was significantly larger than in (4) of FIG. 3. In (4) of FIG. 3, the impedance variation value is almost zero. The method in (4) of FIG. 3 is problematic because the impedance variation value is very small, making it difficult to measure, and even if measured, there is a high possibility of errors.

As described above, the method for evaluating the characteristics of a magnetorheological fluid according to another embodiment of the present invention, by measuring the impedance signal with the coil part 30 placed inside the container 10, results in a significantly larger signal, thereby enabling much more accurate and easier evaluation of characteristics.

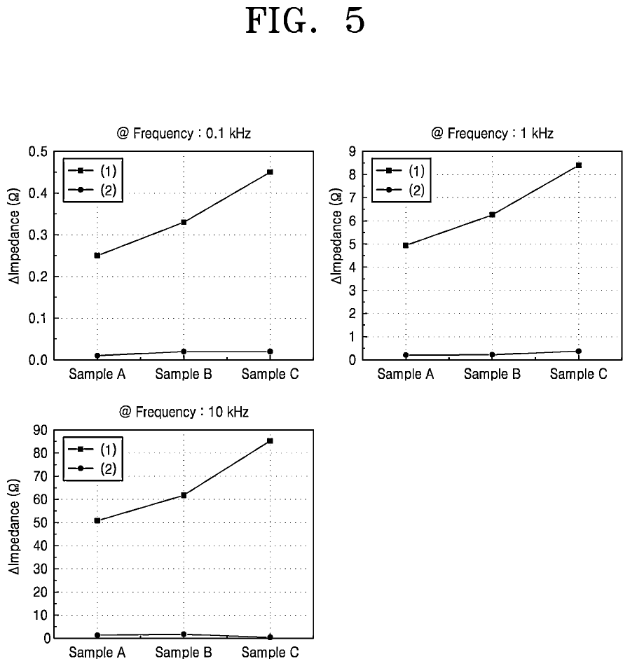

FIG. 5 is a graph showing impedance values of samples with respect to frequency changes according to methods (1) and (2) of FIG. 1.

According to an embodiment, the variation value of impedance was measured by applying electrical signals of 0.1 kHz, 1 kHz, and 10 kHz to the coil part 30 for samples A, B, and C, respectively. Samples A, B, and C are magnetorheological fluids with magnetic particle contents of 72 wt %, 80 wt %, and 85 wt %, respectively. Referring to FIG. 5, it can be seen that in all three graphs, the impedance variation value is significantly larger in the case of (1) of FIG. 1, where the container 10 is placed inside the coil part 30 (or in the hollow portion 35). Additionally, in the case of (1) of FIG. 1, it can be seen that the impedance variation value increases from sample A to sample C, that is, as the magnetic particle content of the magnetorheological fluid 20 increases. In contrast, in the case of (2) of FIG. 1, the magnitude of the impedance variation and the magnetic particle content of the magnetorheological fluid 20 tended to differ depending on the frequency. It appears that the method in (2) of FIG. 1 results in smaller impedance variation values, leading to larger errors and inconsistent results.

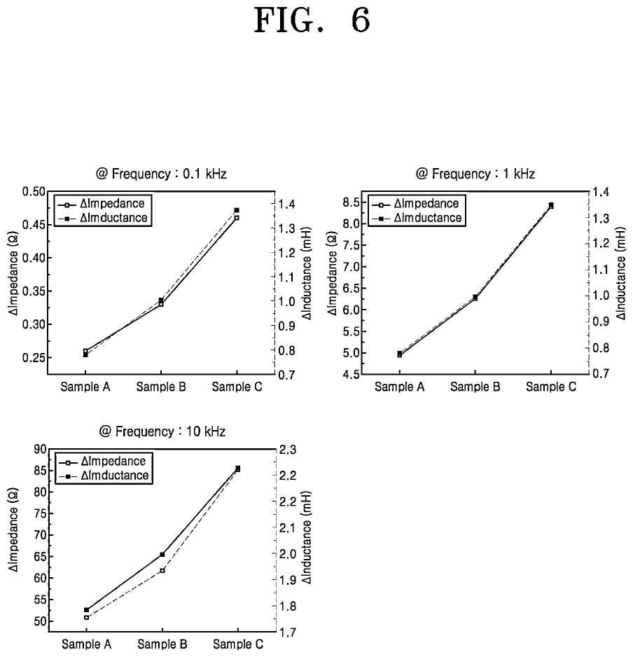

FIG. 6 is a graph comparing impedance values and inductance values of samples with respect to frequency changes according to an embodiment of the present invention.

According to an embodiment, the variation values of impedance and inductance were measured by applying electrical signals of 0.1 kHz, 1 kHz, and 10 kHz to the coil part 30 for samples A, B, and C, respectively. Referring to FIG. 6, it can be seen from the three graphs that the trends of the impedance variation value and inductance variation value are similar or substantially the same regardless of frequency change. This may indicate that the variation value of impedance corresponds to the variation value of inductance of the coil and there is no intervention of other impedance elements (resistance, capacitance). Considering this, the variation value of impedance can be understood as interchangeable with the variation value of inductance in this specification.

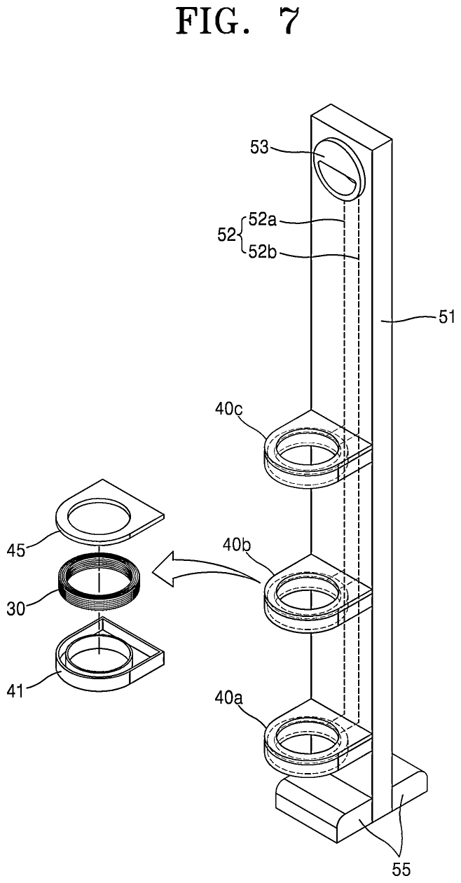

FIG. 7 is a schematic diagram showing a measuring part according to an embodiment of the present invention.

Referring to FIG. 7, a measuring part 50 according to an embodiment of the present invention may be provided to include a coil part 30. One or more coil parts 30 may be provided to be connected to the measuring part 50. In the measuring part 50 of FIG. 7, three coil parts 30 are arranged to be vertically spaced apart from each other, allowing simultaneous measurement of the impedance signal or inductance signal of the magnetorheological fluid 20 at three vertical heights. However, the number and position of the coil parts 30 are not limited to this and may vary according to the desired measurement locations.

The measuring part 50 includes a housing 51 that forms a body, and a coil case 40 may be connected to the housing 51. As shown in FIG. 3, it is also possible to include the coil case 40 inside the housing 51. The coil case 40 (40a, 40b, and 40c) may be provided in a number corresponding to the number of the coil parts 30. Each coil case 40 may include a receiving part 41 that accommodates the coil part 30 and a cover part 45 that covers the receiving part 41 to seal the internal space of the receiving part 41. The coil case 40 is preferably made of a non-magnetic or insulating material to minimize the impact on the electrical signals measured in the coil part 30.

The coil part 30 may be inserted and fixed in the receiving part 41. At this time, an opening may also be formed in the receiving part 41 so that the hollow portion 35 of the coil part 30 is aligned with the receiving part 41 when inserted. The opening may also be formed in the cover part 45. Molding of rubber or similar material may be further formed around the coil part 30 to fix the coil winding inside the receiving part 41.

Coil conductive wires 52 (52a and 52b) of the coil part 30 may extend along the housing 51 of the measuring part 50 and may be connected to a signal measuring device (not shown), allowing for the measurement of an impedance signal or inductance signal.

A grip part 53 of the housing 51 may be formed to be used as a handle for moving the measuring part 50. A weighted part 55 may be installed at the lower end of the housing 51 to prevent the housing 51 from moving due to the buoyancy of the magnetorheological fluid 20 when the measuring part 50 (or the coil part 30) is immersed in the magnetorheological fluid 20.

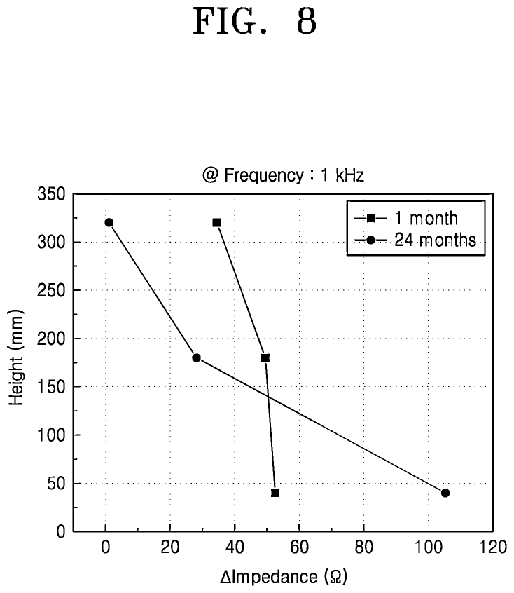

FIG. 8 is a graph showing impedance variation values with respect to the measurement height of a sedimentation sample according to an embodiment of the present invention.

A plurality of coil parts 30 may be placed at different heights of the container 10. Applying (1) of FIG. 1, the container 10 may be placed within the hollow portions 35 of three coil parts 30 spaced apart in the vertical direction. Applying (3) of FIG. 3, three coil parts 30 may be arranged to be spaced apart in the vertical direction in the measuring part 50, and the measuring part 50 may be immersed in the magnetorheological fluid 20. Alternatively, by immersing the measuring part 50 of FIG. 7 in the magnetorheological fluid 20, the coil parts 30 may be made to be immersed in the magnetorheological fluid 20. The height of the coil parts 30 may be arranged to correspond to the height of the magnetorheological fluid 20. That is, the coil parts 30 may be positioned at heights between the lowest and highest points of the magnetorheological fluid 20.

As an example, the bottom of the magnetorheological fluid 20 was set as a reference point (0 mm) and an impedance variation value was measured at each height by using three coil parts 30. The coil parts 30 were placed at heights of approximately 40 mm (first position), 180 mm (second position), and 320 mm (third position). The container 10 was filled with a magnetorheological fluid sample that had been sedimented for 1 month and another magnetorheological fluid sample that had been sedimented for 24 months, and the impedance variation values were measured.

For the sample sedimented for 1 month, the impedance variation values at the first, second, and third positions were approximately 53, 49, and 34(Ω), respectively. For the sample sedimented for 24 months, the impedance variation values at the first, second, and third positions were approximately 105, 28, and 2(Ω), respectively.

Comparing the samples with respect to the first position, the lowest position, the impedance variation value for the sample sedimented for 24 months is significantly larger than that for the sample sedimented for 1 month. This indicates that over time, more magnetic particles are sedimented to the bottom in the sample sedimented for 24 months. Comparing the samples with respect to the second and third positions, the impedance variation value for the sample sedimented for 24 months is significantly smaller than that for the sample sedimented for 1 month. This indicates that for the sample sedimented for 24 months, there are almost no magnetic particles present from the bottom to the top. In other words, it means that the thickness of the upper layer (supernatant liquid) where magnetic particles are separated by sedimentation in the magnetorheological fluid has increased over time. Particularly, at the third position, the impedance variation value for the sample sedimented for 24 months is approximately 2(Ω), indicating that there are almost no magnetic particles present.

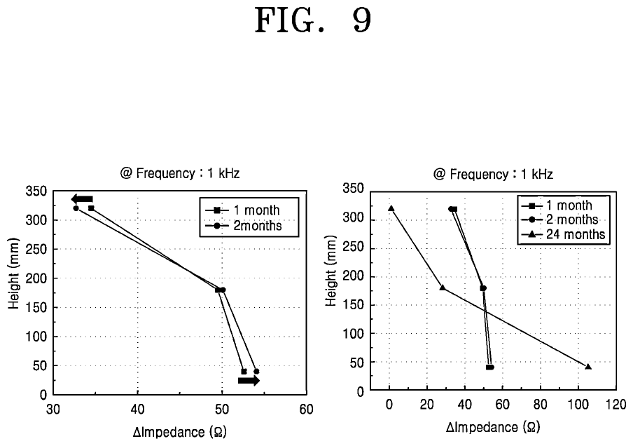

FIG. 9 illustrates graphs showing variation values of impedance with respect to the measurement height of a sedimentation sample after 1 month, 2 months, and 24 months according to an embodiment of the present invention. The sedimentation period was further subdivided to examine the impedance variation value with respect to measurement height.

At the lowest position, the first position, the impedance variation value for the sample sedimented for 2 months is larger than that for the sample sedimented for 1 month. Conversely, at the highest position, the third position, the impedance variation value for the sample sedimented for 2 months is smaller than that for the sample sedimented for 1 month. At the second position, there is almost no difference in the impedance variation values. It can be observed that the impedance variation value increases in the rightward arrow direction from the first position and decreases in the leftward arrow direction from the third position. Examining the right graph of FIG. 9, it can be seen that the difference in impedance variation values at the first and third positions becomes larger as the sedimentation period increases.

If there is no sedimentation and magnetic particles are uniformly mixed throughout the magnetorheological fluid, the impedance variation values at the first, second, and third positions may be the same. That is, the slope of the graph connecting the impedance variation values at the first, second, and third positions may be vertical. For the sample sedimented for 1 month, the degree of sedimentation of magnetic particles is not significant, so the slope of the graph connecting the impedance variation values at the first, second, and third positions may be closer to vertical compared to the sample sedimented for 24 months. For samples with a longer sedimentation period, the slope of the graph connecting any two height points on the X-axis (impedance variation value) and Y-axis (height) may increase negatively.

In the present invention, the data for the sedimentation period according to magnetorheological fluid samples may be set as reference data and the sedimentation rate of the magnetorheological fluid may be calculated based on the difference in impedance signals measured at each height. For example, the sedimentation rate may be calculated through the difference between a first impedance signal measured at the first position and a second impedance signal measured at the second position higher than the first position. In another example, the sedimentation rate and the sedimentation period may be calculated by computing the slope of the graph connecting a first impedance variation value measured at the first position and a second impedance variation value measured at the second position higher than the first position.

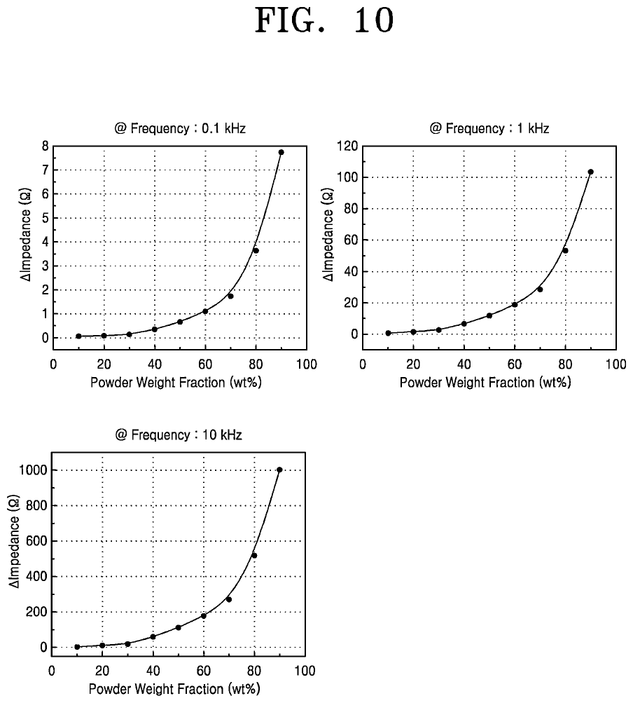

FIG. 10 illustrates graphs showing impedance values with respect to the content of magnetic particles according to an embodiment of the present invention.

According to an embodiment, the variation value of impedance was measured by varying the magnetic particle content of the magnetorheological fluid from 10 wt % to 90 wt %. The content of carbonyl iron powder (CIP) was varied, and electrical signals of 0.1 kHz, 1 kHz, and 10 kHz were applied to the coil part 30 to measure the variation values of impedance. Referring to FIG. 10, it can be seen that the trends of the impedance variation value with respect to the magnetic particle content are similar across the three graphs regardless of frequency change. Therefore, by setting the data of impedance variation values with respect to the magnetic particle content as reference data and measuring the impedance variation value, the content and concentration of magnetic particles in the magnetorheological fluid may be calculated.

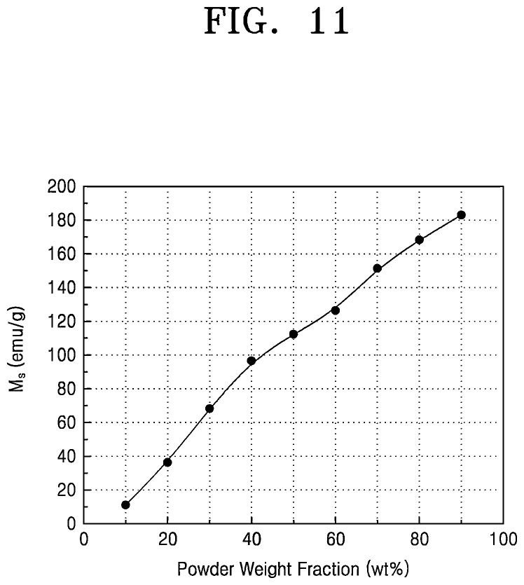

FIG. 11 is a graph showing saturation magnetization values with respect to the content of magnetic particles according to an embodiment of the present invention. Referring to FIG. 11, it can be seen that the saturation magnetization value increases proportionally with the increase in the magnetic particle content. Therefore, by measuring the impedance variation value, the content and concentration of magnetic particles in the magnetorheological fluid may be calculated, and thus the saturation magnetization value may also be easily calculated.

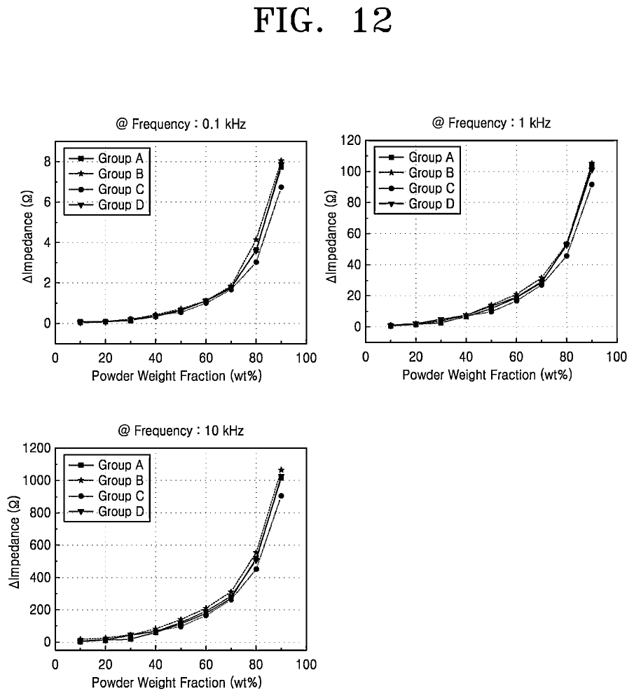

FIG. 12 illustrates graphs showing impedance values with respect to the type of magnetic particles in the magnetorheological fluid according to an embodiment of the present invention.

According to an embodiment, the variation value of impedance was measured by varying the types of magnetic particles in the magnetorheological fluid. Groups A, B, C, and D are magnetorheological fluid samples that contain particle groups α and β, which are made of the same material but have different average particle sizes, in different particle fractions. The fractions (wt %) of particle groups α and β are 75:25 (Group A), 100:0 (Group B), 0:100 (Group C), and 50:50 (Group D). The average particle size of particle group α is about twice that of particle group β.

Referring to FIG. 12, it can be seen from the three graphs that the trends of the impedance variation value for Groups A, B, C, and D are similar regardless of frequency change. The method for evaluating the characteristics of a magnetorheological fluid according to the present invention indicates that the type and size of magnetic particles do not affect the impedance variation value, but only the content and concentration of the magnetic particles do.

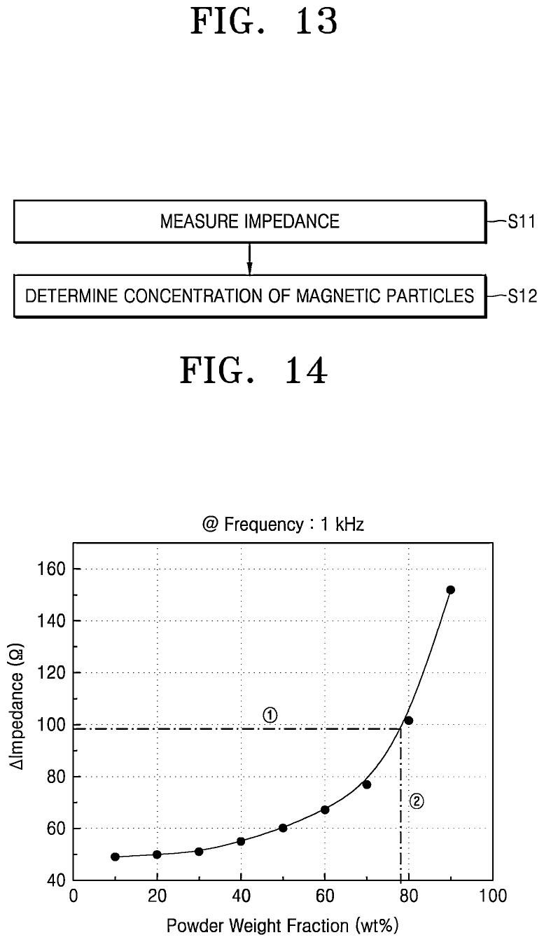

FIG. 13 is a flowchart showing the process of determining the concentration of magnetic particles in a magnetorheological fluid according to an embodiment of the present invention. FIG. 14 is a graph showing the process of determining the concentration of magnetic particles in a magnetorheological fluid according to an embodiment of the present invention.

The method for evaluating the characteristics of a magnetorheological fluid according to an embodiment of the present invention is characterized by including the steps of \textcircled{1} measuring an impedance signal (impedance variation value) of a magnetorheological fluid (S11), and \textcircled{2} determining the concentration of magnetic particles corresponding to the impedance variation value (S12). In addition, as discussed in FIG. 6, since the impedance variation value can be replaced with the inductance variation value, a method for evaluating the characteristics of a magnetorheological fluid according to another embodiment of the present invention is characterized by including the steps of \textcircled{1} measuring an inductance signal (inductance variation value) of a magnetorheological fluid (S11), and \textcircled{2} determining the concentration of magnetic particles corresponding to the inductance variation value (S12).

In step S11 (\textcircled{1}), the container 10 may be placed within the hollow portion 35 of the coil part 30, or the measuring part 50 including the coil part 30 may be immersed in the magnetorheological fluid 20. Alternatively, the magnetorheological fluid 20 may be made to flow through the hollow portion of the coil part 30. An electric signal, such as a current, is applied to the coil part 30, which interacts with the adjacent magnetorheological fluid, and an impedance signal or inductance signal may be measured by a signal measuring device (not shown) to which both ends of the coil conductive wire of the coil part 30 are externally connected.

Next, in step S12 (\textcircled{2}), the concentration of magnetic particles may be determined from the reference data collected in advance. The concentration of magnetic particles in the part of the magnetorheological fluid 20 where the coil part 30 is located may be determined by matching the magnetic particle concentration value corresponding to the measured impedance variation value on the graph in FIG. 14.

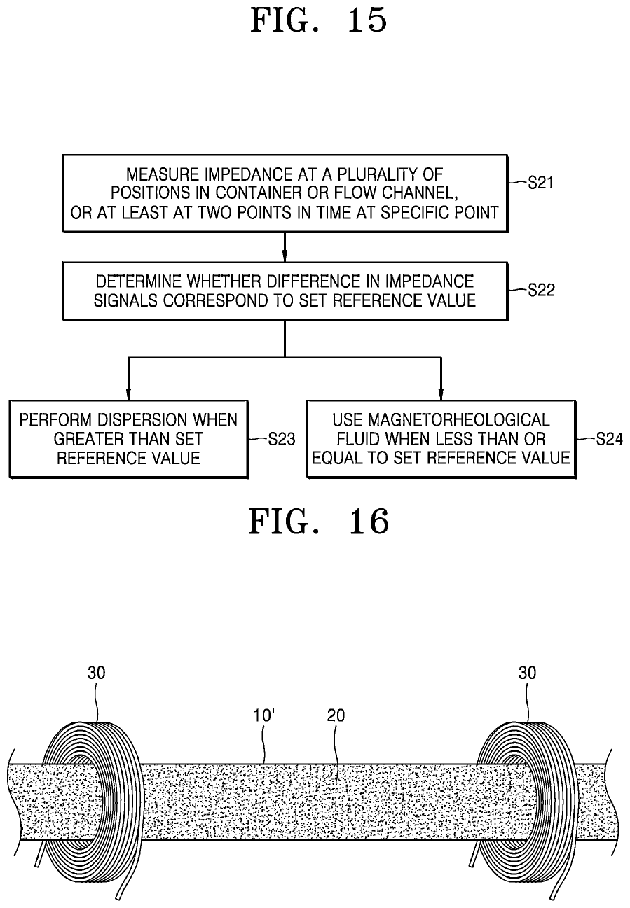

FIG. 15 is a flowchart showing the processes for use of a magnetorheological fluid, such as determining the time of completion of the manufacturing process, quality control of sedimentation or re-dispersibility, injection, etc. by determining the uniformity of dispersion of the magnetorheological fluid according to an embodiment of the present invention. FIG. 16 is a schematic diagram showing a method for evaluating the characteristics of a magnetorheological fluid in a flow channel 10′ where the magnetorheological fluid 20 flows according to an embodiment of the present invention.

The method for evaluating the characteristics of a magnetorheological fluid according to an embodiment of the present invention is characterized by including the steps of (1) measuring an impedance signal or inductance signal at multiple positions in the container 10 or the flow channel 10′, or at least at two points in time at a specific point (S21) and (2) determining whether a difference in impedance signals or inductance signals corresponds to a set reference value (S22), wherein if the difference is greater than the set reference value, dispersion of the magnetorheological fluid 20 is further performed (S23) and if the difference is less than or equal to the set reference value, the magnetorheological fluid 20 is used (S24).

In step S21, the impedance signal or inductance signal may be measured at least at two heights of the container 10. The hollow portion 35 of the coil part 30 may be positioned at each of least at two height positions of the container 10, or the measuring part 50 may be immersed in the magnetorheological fluid 20 to position the coil part 30 at each of least at two height positions. An electric signal, such as a current, is applied to each coil part 30, which interacts with the adjacent magnetorheological fluid, and an impedance signal or inductance signal may be measured by a signal measuring device (not shown) to which both ends of the coil conductive wire of each coil part 30 are externally connected.

Alternatively, the impedance signal or inductance signal may be measured at least at two positions in the flow channel 10′. It is preferable that a tube providing the flow channel 10′ is made of a non-magnetic, non-conductive material, like the container 10. The hollow portion 35 of the coil part 30 may be positioned at each of the least at two height positions of the flow channel 10′, or the measuring part 30 may be immersed in the flow channel 10′ to position the coil part 30 at each of the least at two height positions.

Alternatively, an impedance signal or inductance signal may be measured at least at two different points in time based on a specific point in the container 10 or the flow channel 10′. For example, the impedance or inductance signal may be measured from the coil part 30 at multiple times such as t1 and t2.

Next, in step S22, it may be determined whether the difference in impedance signals or inductance signals, that is, the difference in impedance or inductance variation values, corresponds to the set reference value. The set reference value may correspond to reference data collected in advance from a magnetorheological fluid with the same magnetic particle content. For example, the ratio of the impedance or inductance variation value measured at the second position, which is the topmost position, to the impedance or inductance variation value measured at the first position, which is the bottommost position of the magnetorheological fluid, may be calculated and compared to a ratio that serves as a reference for settings. In another example, the ratio of the impedance or inductance variation values measured at multiple times such as t1 and t2 through the coil part 30 at a specific position may be calculated and compared to the ratio that serves as a reference for settings.

Next, when it is determined that the difference in impedance signals or inductance signals is greater than the set reference value, dispersion of the magnetorheological fluid 20 may be further performed (step S23). A difference in impedance signals or inductance signals greater than the set reference value indicates the magnetic particles are significantly sedimented, resulting in poor uniformity of magnetic particles and making it difficult to use the magnetorheological fluid in processes or products. Therefore, the magnetorheological fluid may be stirred to re-disperse the magnetic particles within the dispersion medium. After re-dispersion, steps S21 and S22 may be repeated. For example, if the set reference value is set as a ratio, such as 97%, and the impedance variation value measured at the second position is less than 97% of the impedance variation value measured at the first position, dispersion of the magnetorheological fluid may be further performed.

The set reference value may be determined according to the application product to which the magnetorheological fluid is applied. For example, in magnetorheological fluid dampers or magnetorheological fluid brake products, the set reference value may be set to a smaller range within a specification range for the shear stress-related characteristics exhibited by the magnetic particles in the magnetorheological fluid. For instance, if the specification range of the damping force, which is a characteristic related to the shear stress of the magnetorheological fluid in a magnetorheological fluid damper, is ±10%, the set reference value may be set within ±1% of that specification.

On the other hand, if the difference in impedance signals is determined to be less than or equal to the set reference value, the magnetorheological fluid 20 may be used in processes or products. For example, if the set reference value is set as a ratio, such as 97%, and the impedance variation value measured at the second position is greater than or equal to 97% of the impedance variation value measured at the first position, the magnetorheological fluid can be evaluated as usable because sedimentation has not progressed significantly and the dispersion is uniform.

The method for evaluating the characteristics of a magnetorheological fluid in the present invention may be used in the production stage of a magnetorheological fluid, quality control stage, incoming inspection stage by a magnetorheological fluid user, magnetorheological fluid injection stage by the user, and other similar stages.

In the production stage, the content and concentration of magnetic particles in the magnetorheological fluid 20 may be easily measured in real-time using the coil part 30. By mounting or immersing the coil part 30 in the production or injection facility of the magnetorheological fluid and continuously or intermittently monitoring the impedance or inductance signals over time, it is possible to determine abnormalities or the endpoint in the production process. In addition, by comparing the impedance or inductance signals from multiple coil parts 30 installed at a plurality of positions in the production or injection facility, the completeness of the formulation of the magnetorheological fluid in the production facility may be evaluated.

Moreover, to determine any abnormalities in the composition of the magnetorheological fluid during the production stage, the magnetorheological fluid continuously flowing through the coil part 30 may be measured. The magnetorheological fluid flowing around or through the hollow portion 35 of the coil part 30 may be measured. For example, by measuring the impedance or inductance signals from the coil part 30 at multiple times such as t1 and t2, it may be determined whether the signals correspond to the set reference value. If the signals do not correspond to the set reference value, it may be determined that the content of magnetic particles in the magnetorheological fluid during the production process is low, and additional dispersion or component correction process may be performed.

In the quality control stage, as already described with reference to FIG. 8 and the subsequent drawings, the sedimentation rate and the uniformity of dispersion may be evaluated by measuring the impedance or inductance signals of the magnetorheological fluid 20 at a plurality of positions.

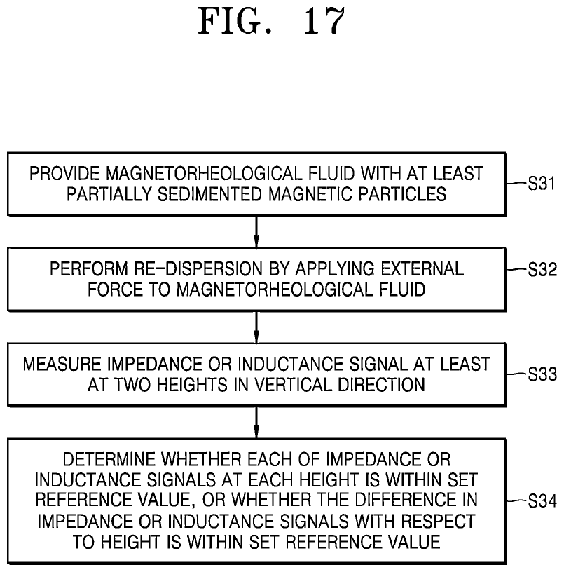

FIG. 17 is a flowchart showing the process of evaluating the re-dispersibility of a magnetorheological fluid according to an embodiment of the present invention.

When evaluating the re-dispersibility of a magnetorheological fluid, a magnetorheological fluid with at least partially sedimented magnetic particles may be provided (S31), and re-dispersion may be performed by applying an external force to the sedimented magnetorheological fluid S32. After applying the external force, an impedance or inductance signal may be measured at least at two heights in the vertical direction S33. Then, by determining whether each of the impedance or inductance signals at each height is within the set reference value, or whether the difference in impedance or inductance signals with respect to height is within the set reference value (S34), it may be confirmed whether sufficient re-dispersion has occurred.

In addition, during the incoming inspection stage by a magnetorheological fluid user, the content, concentration, sedimentation rate, etc. of magnetic particles in a relatively older magnetorheological fluid may be checked. If the values do not meet the set reference values, a re-dispersion process may be further performed to ensure the use of the magnetorheological fluid that has the desired characteristics. This may be useful in the magnetorheological fluid injection stage to verify whether the magnetorheological fluid is sufficiently dispersed before injecting it into magnetorheological systems (MR systems) such as a magnetorheological damper (MR damper).

In the method for evaluating the characteristics of a magnetorheological fluid according to the present invention, the measuring part shown in FIG. 7 may be used in the production stage, quality control stage, incoming inspection stage by a magnetorheological fluid user, magnetorheological fluid injection stage by the user, and other similar stages.

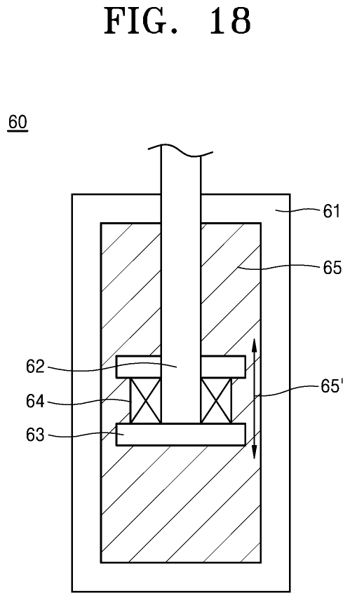

FIG. 18 is a schematic diagram showing a magnetorheological fluid damper 60 according to an embodiment of the present invention.

Referring to FIG. 18, a magnetorheological fluid damper 60 may adjust the damping force using a magnetorheological fluid 65. The magnetorheological fluid damper 60 may include a cylinder housing 61, piston parts 62 and 63, a coil part 64, and the magnetorheological fluid 65.

The cylinder housing 61 has a sealed structure, and the sealed internal space may be filled with the magnetorheological fluid 65.

The piston parts 62 and 63 may include a piston rod 62 extending in the longitudinal direction within the cylinder housing 61 and a piston head 63 provided at the end of the piston rod 62. The piston rod 62 may move up and down due to external vibrations or shocks. The piston head 63 is formed with an outer diameter corresponding to the inner diameter of the cylinder housing 61 and divides the interior of the cylinder housing 61 into upper and lower spaces, allowing the magnetorheological fluid 65 to be placed in each space. When the piston rod 62 moves up and down, the magnetorheological fluid 65 may flow through at least a gap of the piston head 63.

An electromagnet may be configured in the piston parts 62 and 63, and the coil part 64 may be placed inside or at least on the outer circumferential surface of the piston parts 62 and 63. As a current is applied from an external source, the coil part 64 may generate a magnetic field. The generated magnetic field is applied to the magnetorheological fluid 65, allowing the viscosity and yield stress of the magnetorheological fluid 65 to be adjusted. The coil part 64 and the magnetorheological fluid 65 correspond to the aforementioned coil part 30 and magnetorheological fluid 20.

The magnetorheological fluid damper 60 is not necessarily limited to the above configuration, and various configurations can be employed as long as they serve the purpose of adjusting the damping force by changing the viscosity of the magnetorheological fluid.

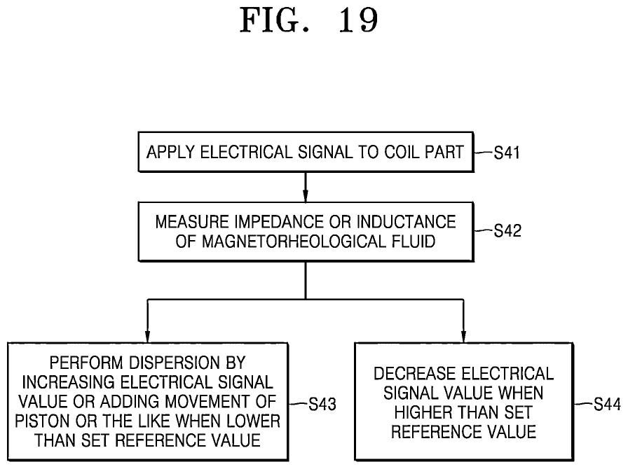

FIG. 19 is a flowchart showing the operation process of a magnetorheological fluid system according to an embodiment of the present invention. Although the operation process is explained using the magnetorheological fluid damper 60 as an example, it should be noted that this can be equally applied to a magnetorheological fluid system such as a magnetorheological fluid brake.

According to an embodiment of the present invention, in the process of operating the magnetorheological fluid damper 60, an electrical signal may be applied to the coil part 64 (S41). Then, an impedance or inductance signal of a magnetorheological fluid 65′ flowing through the piston parts 62 and 63 may be measured through the coil part 64 (S42). Accordingly, the concentration or content of magnetic particles in the magnetorheological fluid damper 60 may be determined.

If the signal measured in the magnetorheological fluid damper 60 is lower than the set reference value, for example, if it is determined that the concentration or content of magnetic particles in the magnetorheological fluid damper 60 is low, the strength of the electrical signal to be applied to the coil part 64 may be increased to generate a larger magnetic field, thereby increasing the viscosity of the magnetorheological fluid 65 and controlling it to meet the target damping force. Alternatively, the concentration or content of magnetic particles may be adjusted to correspond to the set reference value by adding the movement of the piston parts 62 and 63 to perform dispersion (S43).

Conversely, if the signal measured in the magnetorheological fluid damper 60 is higher than the set reference value, for example, if it is determined that the concentration or content of magnetic particles in the magnetorheological fluid damper 60 is high, the strength of the electrical signal applied to the coil part 64 may be reduced to generate a smaller magnetic field, thereby decreasing the viscosity of the magnetorheological fluid 65 and controlling it to meet the target damping force.

As described above, the present invention has the effect of accurately evaluating the characteristics of a magnetorheological fluid, such as the content, concentration, and sedimentation rate, etc. of magnetic particles, in a simple manner. Moreover, it has the effect of protecting the physical properties of the magnetorheological fluid and improving economic efficiency by performing minimal re-mixing/re-dispersion for the magnetorheological fluid in which magnetic particles are sedimented, thereby omitting unnecessary processes.

Although the present invention has been shown and described with reference to preferred embodiments as described above, the present invention is not limited to the above embodiments, and within the scope without departing from the spirit of the present invention, various modifications and changes can be made by those skilled in the art. It should be considered that such modification examples and change examples belong to the scopes of the present invention and the appended claims.

1. A method for evaluating characteristics of a magnetorheological fluid containing magnetic particles, the method comprising the following steps of:
(a) preparing a container in which a magnetorheological fluid is filled or a flow channel in which a magnetorheological fluid flows;
(b) placing a coil part such that the container or flow channel is positioned in a hollow portion of the coil part; and
(c) measuring an impedance signal or inductance signal with respect to the magnetorheological fluid through the coil part.

2. A method for evaluating characteristics of a magnetorheological fluid containing magnetic particles, the method comprising the following steps of:
(a) preparing a container in which a magnetorheological fluid is filled or a flow channel in which a magnetorheological fluid flows;
(b) preparing a measuring part with a coil part placed inside or connected externally;
(c) immersing the coil part in the magnetorheological fluid; and
(d) measuring an impedance signal or inductance signal with respect to the magnetorheological fluid through the coil part.

3. The method of claim 1, wherein the container or a tube in which the flow channel is formed is made of a non-magnetic or non-conductive material.

4. The method of claim 2, wherein a case of the measuring part is made of a non-magnetic or non-conductive material.

5. The method of claim 1, wherein when the container or the flow channel is positioned in the hollow portion of the coil part, magnitude of the impedance signal or inductance signal is measured to be more than ten times greater than when the container or the flow channel is positioned in an outer peripheral region of the coil part.

6. The method of claim 5, wherein as content of magnetic particles in the magnetorheological fluid increases, a difference in impedance signals or inductance signals becomes greater when the container or the flow channel is positioned in the hollow portion of the coil part compared to when the container or the flow channel is positioned in the outer peripheral region of the coil part.

7. The method of claim 2, wherein, when the coil part is immersed in the magnetorheological fluid, magnitude of the impedance signal or inductance signal is measured to be more than ten times greater than when the container or the flow channel is positioned in an outer peripheral region of the coil part.

8. The method of claim 7, wherein as content of magnetic particles in the magnetorheological fluid increases, a difference in impedance signals or inductance signals becomes greater when the coil part is immersed in the magnetorheological fluid compared to when the container or the flow channel is positioned in the outer peripheral region of the coil part.

9. The method of claim 1, wherein the impedance signal or inductance signal with respect to the magnetorheological fluid is measured through the coil part for each height of the container filled with the magnetorheological fluid.

10. The method of claim 9, wherein a sedimentation rate of the magnetorheological fluid is calculated based on (1) a difference between a first impedance signal measured at a first position in the container and a second impedance signal measured at a second position higher than the first position, or (2) a difference between a first inductance signal measured at a first position in the container and a second inductance signal measured at a second position higher than the first position.

11. The method of claim 10, wherein as time passes from a reference point in time, the difference between the first impedance signal and the second impedance signal, or the difference between the first inductance signal and the second inductance signal, increases.

12. The method of claim 10, wherein as time passes from a reference point in time, (1) the first impedance signal increases while the second impedance signal decreases, or (2) the first inductance signal increases while the second inductance signal decreases.

13. The method of claim 1, wherein a concentration of the magnetic particles of the magnetorheological fluid is calculated by measuring the impedance signal or inductance signal with respect to the magnetorheological fluid through the coil part.

14. The method of claim 1, wherein a plurality of coil parts spaced apart from one another along a vertical direction of the container are prepared and the container is disposed in the hollow portions of at least two of the coil parts.

15. The method of claim 2, wherein
the measuring part comprises a plurality of coil parts arranged to be spaced apart from one another along a vertical direction of the container, and
the measuring part is immersed in the magnetorheological fluid such that heights of at least two of the coil parts of the measuring part are positioned lower than a topmost level of the magnetorheological fluid.

16. The method of claim 1, wherein the impedance signal or inductance signal with respect to the magnetorheological fluid is measured through the coil part at least at two different points in time at a specific point in the container filled with the magnetorheological fluid.

17. The method of claim 1, wherein measuring of the impedance signal or inductance signal with respect to the magnetorheological fluid through the coil part comprises:
(1) measuring the impedance signal or inductance signal at least at two points in time or at least at two points in the container or flow channel; and (2) determining whether a difference between the impedance signals or inductance signals measured at the at least two points in time or at the at least two points is greater than a set reference value.

18. The method of claim 1, wherein measuring of the impedance signal or inductance signal with respect to the magnetorheological fluid through the coil part comprises:
(1) measuring the impedance signal or inductance signal at least at two points in time or at least at two points in the container or flow channel; and
(2) determining whether each of the impedance signals or the inductance signals measured at the at least two points in time or at the at least two points falls within a preset reference value range.

19. The method of claim 17, wherein when the difference between the impedance signals or inductance signals measured at the at least two points in time or at least two points is greater than the set reference value, dispersion of the magnetorheological fluid is further performed.

20. The method of claim 17, wherein the magnetorheological fluid is used under a condition that the difference between the impedance signals or inductance signals measured at the at least two points in time or at the at least two points is equal to or less than the set reference value.

21. The method of claim 18, wherein when difference between the impedance signals or inductance signals measured at the at least two points in time or at the at least two points is out of a preset reference value range, dispersion of the magnetorheological fluid is further performed.

22. The method of claim 18, wherein the magnetorheological fluid is used when difference between the impedance signals or inductance signals measured at the at least two points in time or at the at least two points is within the preset reference value range.
